(19) United States
(12) Patent Application Publication
(10) Pub. No.: US 2011/0297269 A1
(43) Pub. Date: Dec. 8, 2011

(54) METAL TUBE WITH POROUS METAL LINER

(75) Inventors: Dominic Pilon, Montreal (CA); Sebastien Labbe, Saint-Jean-Sur-Richelieu (CA); Noemie Savoie, Brossard (CA)

(73) Assignee: METAFOAM TECHNOLOGIES INC., Brossard, QC (CA)

(21) Appl. No.: 13/202,894

(22) PCT Filed: Feb. 23, 2010
(86) PCT No.: PCT/CA2010/000239

§ 371 Date: Aug. 23, 2011

Related U.S. Application Data
(60) Provisional application No. 61/154,752, filed on Feb. 23, 2009.
(60) Provisional application No. 61/184,579, filed on Jun. 5, 2009.

(51) Int. Cl. F16L 9/18; B21D 11/00; B23K 20/00

(52) U.S. Cl. 138/141; 493/303; 228/193; 72/368

(57) ABSTRACT

A metal tube having an inner wall coated with a metal foam liner. The metal tube has an outer diameter of between 2 mm and 75 mm, a length of between 10 mm and 1000 mm, and a wall thickness of between 0.2 mm and 2 mm. The metal foam liner has a thickness of between 0.1 mm and 10 mm, a permeability of between 10⁻¹³ m² and 10⁻⁸ m², a capillarity radius of between 5 μm and 1 mm and a thermo-conductivity of between 1 W/m·K and 50 W/m·K. Also, a method to obtain a metal tube which inner wall is metallurgically bonded in thermo-conduction with a metal foam liner, a method to obtain a metal tube with a heterogeneous metal foam liner, and a method to obtain a tubular metal foam liner 10a from a sheet of metal foam.

### CROSS-REFERENCE

The present application claims priority to U.S. Provisional Patent Application No. 61/154,752 filed Feb. 23, 2009 entitled “Metal Tube with Metal Foam Liner”, and to U.S. Provisional Patent Application No. 61/184,579 filed Jun. 5, 2009 entitled “Metal Tube with Heterogeneous Metal Liner”, the entireties of which are incorporated herein by reference.

### FIELD OF THE INVENTION

The present invention relates to metal tubes having porous metallic liners therein serving as wicking structures, as well as to methods of making such tubes.

### BACKGROUND OF THE INVENTION

In many applications, components need to be cooled so as to maintain their temperature within a range in which they can reliably operate. This is especially the case in the electronics industry where the power density of electronics is ever increasing while their enclosures are becoming ever smaller. Among the cooling solutions, heat pipes have found wide acceptance. Heat pipes have a flexible design and are capable of transporting relatively large quantity of heat.

A heat pipe is basically a heat transfer device using a fluid in phase transition to transport heat between a hot interface (“the hot side”) and a cold interface (“the cold side”). Typically, a heat pipe consists of a sealed pipe or tube made of a material with adequate thermal conductivity (such as copper or aluminum) whose inner wall is lined with a wicking structure surrounding a void space. The interior of the sealed tube (including both the wicking structure and the void space) is typically under a vacuum and is filled with a fraction of a percent by volume of working fluid (as known as the coolant). The working fluid and material of the wicking structure and the pipe are all chosen to match the operating characteristics, and particularly the operating temperature range, of the heat pipe. Some examples of working fluids are water, ethanol, acetone, sodium, or mercury.

At the hot side, the heat pipe receives the heat to be transferred from an external heat source, vaporizing the working fluid. The working fluid in gaseous form then flows through the void space to the cold side. The cold side is in thermal communication with a heat sink. The working fluid at the cold side condenses, sending the heat to be transferred to the heat sink. The wicking structure exerts a capillary pressure on the now liquid phase of the working fluid to move the fluid back to the hot side where it can be vaporized again. The characteristics of the wicking structure influence the performance of the heat pipe. Wicking structures can be any material capable of exerting capillary pressure on the condensed liquid to wick it back to the hot end. Usually they comprise sintered metal powder, wire mesh or series of grooves parallel to the pipe axis.

Current conventional heat pipes use sintered powder liners as wicking structures. Sintered powders liners are metallic porous material having a porosity typically lower than 50% void volume. Even though sintered powder liners are widely used in heat pipes, they are becoming no longer able to meet industry demand in terms of heat transport capability.

Therefore there is a need for an improved metal tube with a metal porous liner useable in a heat pipe. There is also a need for a method to make such improved wicking structure.

Recently, metal foams have gained interest among the wicking structures due to their improved wicking properties as compared to sintered powder wicks. Metal foams are mostly open cell porous structures having a larger void volume fraction (i.e. porosity) than sintered powders. Open cell wicking structures have proven to yield to high performances in heat management. These pores (or open cells) form an interconnected network which is especially suitable for capillary transport of fluids. Metal foams contain a large volume fraction of the gas-filled pores and have a high porosity, typically 75-95% void volume, compared to sintered powders. Metal foams become much stronger as they get denser. For example, a 20% dense material is more than twice as strong as a 10% dense material. Metal foams typically retain some (but not all) physical properties of their base material.

Despite being interesting candidates for wicking structures, conventional metal foams have in some situations been found inadequate for use in many heat pipes. Conventional metal foams have large pore sizes leading to a large capillary radius, which leads to a small capillary force. As such, conventional metal foam generally cannot pump the working fluid fast enough for adequate heat pipe performance. Furthermore, conventional metal foams tend to have a microstructure and a high porosity (typically above 90%) that makes bonding (both mechanical and thermally conductive bonding) between the metal foam and the inner wall of the metal tube difficult.

Current methods of making a metal tube with a sintered powder liner useable for a heat pipe consist in positioning a mandrel of smaller diameter inside the metal tube, pouring powder in the space left in between the mandrel and the metal tube, and sintering the powder to form a sintered powder wick that is bonded to the tube walls. These conventional techniques do not enable one to effectively control the thickness of the wicking structure formed in between the mandrel and the metal tube. Only one side of the mandrel is fixed into a position, and the other side of the mandrel rests at the bottom of the metal tube without being fixed into a specific position. Small displacements of the free end of the mandrel within the tube and small curves in the mandrel itself result in a wicking structure having a thickness that is not uniform. This lack of uniformity, along with zones of the wicking structure being deformed from over-compression typically negatively affects wicking and heat transfer capacity performances.

Therefore, there is an additional need for a method of making a metal tube with a porous material liner, where the method allows for improvement in the control of the positioning and thickness of the porous material liner within the tube as compared with conventional techniques.

### SUMMARY OF THE INVENTION

It is thus an object of the present invention to ameliorate at least some of the inconveniences present in the prior art.

It is also an object of the present invention to provide a metal tube with a wicking structure that is improved when compared with at least some of the prior art metal tubes with porous liners.

It is another object of the present invention to provide a method for making a metal tube lined with porous liner. It is a further object to better control the thickness of the porous liner for use a metal tube with porous liner during its manufacture.

In one aspect, the invention provides a metal tube with a metal foam liner as a wicking structure for use in the manufacture of a heat pipe. The metal tube has an inner wall and an outer wall, and at least one open end. The metal tube has an outer diameter of between 2 mm and 75 mm, a length of between 10 mm and 1000 mm, and a wall thickness of between 0.2 mm and 2 mm. The metal foam liner lines at least partially the inner wall of the metal tube. At least a portion of an outer wall of the metal foam liner is thermo-conductively bonded to the inner wall of the metal tube. The metal foam liner has a thickness of between 0.1 mm and 10 mm, a permeability of between 10⁻¹³ m² and 10⁻⁸ m², a capillarity radius of between 5 μm and 1 mm, and a thermo-conductivity of between 1 W/m·K and 50 W/m·K. The metal foam liner has increased porosity compared to sintered powder and has a smaller pore size compared to conventional metal foam, which makes good candidate for use in a heat pipe.

The metal tube and metal foam liner have both properties that are selected depending on the application they are intended to be used in. For some applications, it is preferred that the outer diameter of the metal tube is of between 3 mm and 50 mm. For some applications, it is preferred that the outer diameter of the metal tube is of between 4 mm and 50 mm. In some cases, it is preferred that the length of the metal tube is of between 50 mm and 1000 mm. For some applications, it is preferred that, the permeability of the metal foam liner is of between 10⁻¹² m² and 10⁻⁹ m². For some applications, it is preferred that the permeability of the metal foam liner is of between 10⁻¹¹ m² and 10⁻⁹ m². For some applications, it is preferred that the capillary radius of the metal foam liner is of between 10 μm and 500 μm. For some applications, it is preferred that the capillary radius of the metal foam liner is of between 20 μm and 250 μm. For some applications, it is preferred that the thermo-conductivity of the metal foam liner is of between 3 W/m·K and 30 W/m·K. For some applications, it is preferred that the thermo-conductivity of the metal foam liner is of between 4 W/m·K and 20 W/m·K. For the purposes of this application, when ranges are used, it should be understood that end points of the ranges are included in the range.

In a further aspect, the metal foam liner is made from a metal foam having two pore groups. Such metal foam is disclosed in the International Patent Application Publication No. WO 2007/121575 published on Nov. 1, 2007 entitled “Heat Management Device Using Inorganic Foam”, and in the International Patent Application Publication No. WO 2009/049397 published on Apr. 23, 2009 entitled “Heat Management Device Using Inorganic Foam”, by the present Applicants, the entireties of which are incorporated herein by reference. In such foams of the present invention, the first pore group has an average pore size in the range between about 20 μm to about 200 μm. The first pore size group constitutes from about 40% to about 80% of the void volume of the porous structure. The second pore group has an average pore size in the range from about 250 nm to about 40 μm. The second pore size group constitutes from about 20% to about 50% of the void volume of the porous structure. These metal foams have a smaller pore size on average than conventional metal foams and the metal foams of the '224 and '828 patents. A smaller pore size lowers thermal resistance. This denser metal foam is preferred in applications where high thermal conductivity is desired.

It is preferred that the first pore group has an average pore size in the range from about 40 μm to about 150 μm, and the second pore group has an average pore size in the range from about 500 nm to about 30 μm.

It is more preferred that the first pore group has an average pore size in the range from about 60 μm to about 100 μm, and the second pore group has an average pore size in the range from about 500 nm to about 20 μm.

In some cases, the metal foam liner is made from a metal foam having a third pore group. The third pore group has an average pore size of between about 100 μm and about 1 mm. Such metal foam is disclosed in U.S. Pat. No. 6,660,224 (hereinafter '224) issued on Dec. 9, 2003 entitled “Method of Making Open Cell Material”, and in U.S. Pat. No. 7,108,828 (hereinafter '828) issued on Sep. 19, 2006 entitled “Method of Making Open Cell Material”, the entireties of which are incorporated herein by reference. This metal foam offers (1) higher pumping speed (or wicking speed) due to a higher permeability to capillarity radius ratio, and (2) a higher porosity for handling greater amounts of working fluids, in comparison with sintered powder wicks. This metal foam is preferred in applications where high power is desired.

It is preferred that the metal foam liner and the metal tube are each made of one or more materials selected from the group consisting of: metallic particles, metallic alloy and/or a combination thereof having at least one transition metal, and more preferably from at least one transition metal selected from the group consisting of scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, and gold.

It is more preferred that the metal foam liner and the metal tube are each made of one or more materials selected from the group consisting of: copper, titanium, nickel, aluminum, steel, stainless steel, and silver.

The combination of materials for the metal tube and for the metal foam liner depends on what the use of the metal tube with porous metal liner will be. For example, if used in a heat pipe that encloses liquid sodium, stainless steel or nickel will likely be a preferred choice. In another non-limiting example, if water is used in a heat pipe, copper would likely be an appropriate choice of material. In other embodiments, such as when used in a corrosive environment, the metal tube would be stainless steel while the metal foam liner might be copper. In certain applications, it is preferred that the metal foam liner is made of a same material as the metal tube. In some of these applications, it is even more preferred that the metal foam liner and the metal tube are each made of copper. For example, in applications where the tube with liner is used at approximately ambient temperature with water as a working fluid, copper is a preferred choice.

It is generally preferred that a porosity of the metal foam liner is of between 40% and 90% void volume. It is even more preferred that the porosity of the metal foam liner is of between 50% and 85% void volume. The choice of the amount of porosity depends on the use of the metal foam. For example, a higher porosity is desired when great amounts of working fluids have to be handled, whereas lower porosity is preferred when thermal resistance is an issue.

It is preferred that the outer wall of the metal foam liner is thermo-conductively bonded to the inner wall of the metal tube via sintering. Sintering has the advantage of not having to introduce an additional material during the making of the metal tube with porous metal liner. In some cases, where the addition of a brazing agent is not an issue, the outer wall of the metal foam liner is thermo-conductively bonded to the inner wall of the metal tube via brazing.

It is preferred that the metal tube is seamless. In some cases, the at least one open end of the metal tube is a first open end, and the metal tube has a second open end. In other cases, the at least one open end is a single opening. Either way, in some cases, the at least one open end of the metal tube is free of burrs.

Preferably, the metal tube is straight, and however, the metal tube may be curved.

For certain applications, it is preferred that a length of the metal foam liner is equal to the length of the metal tube.

It is preferred that, for certain applications, the metal liner is heterogeneous. A heterogeneous metal liner can be constituted of more than one type of metal foam, and/or more than one type of sintered powder liner. Heterogeneous liners are preferred when different properties of the metal liner are exploited at different spatial locations. In one embodiment, the metal foam liner is shorter than the metal tube, and a sintered powder liner is thermo-conductively bonded to at least a portion of the inner wall of the metal tube where the metal tube is not lined with the metal foam liner. As an example, in a heat pipe made form a metal tube having such a metal foam and being used to cool the CPU of a computer, one can use a heterogeneous liner to have increased heat transfer to the heat pipe in the area adjacent to the CPU, and decreased heat transfer from the heat pipe in the adiabatic section, so as to cool the CPU with greater efficiency. For example, the heat resistance of a metal tube with an homogeneous metal foam liner above the CPU at 35 W is about 0.5° C./W (calculated using the temperature of CPU−T_{junction}—and the temperature at the surface of the metal tube on the other side of the contact with the CPU−Tₑᵥₐₚₒᵣₐₜₒᵣ). A maximum heat load capacity of the metal tube with the homogeneous metal foam liner in the adiabatic and condenser sections is more than 35 W. By contrast, a metal tube with a homogeneous sintered powder liner has a heat resistance of about 0.3° C./W above the CPU at 35 W and a maximum heat load capacity of no more than 35 W. As well, the sintered powder liner has a smaller wicking speed than the metal foam liner. Therefore, a heterogeneous liner wherein a sintered powder liner portion is located above the CPU and a metal foam liner portion is located in the adiabatic and condenser sections, would allow one to exploit the low heat resistance of the sintered powder liner above the CPU and the high wicking speed of the metal foam liner in the adiabatic and condenser sections, which would lead to a maximum heat load capacity relatively higher than a metallic tube with sintered powder lining alone.

For some applications having a heterogeneous liner, it is preferred that the thickness of the sintered powder liner be smaller than the thickness of the metal foam liner.

It is preferred that, for certain particular applications: the outer diameter of the metal tube is 6 mm; the length of the metal tube is 300 mm; the wall thickness of the metal tube is 0.3 mm; and the thickness of the metal foam liner is 0.7 mm. Also, the permeability and the capillarity radius of the metal foam liner are such that a ratio of permeability over capillarity radius is maximized. The thermo-conductivity of the metal foam liner is of between 20 W/m·K to 30 W/m·K. It is even more preferred that the porosity of the metal foam liner is of between 70% and 85% void volume, a heat resistance of the metal tube with the metal foam liner at 35 W is about 0.5° C./W, a porosity of the sintered powder liner is of between 45% and 55% void volume, and a heat resistance of the metal tube with the sintered powder liner at 35 W is about 0.3° C./W.

In another aspect as embodied and broadly described herein, the present invention provides a method for making a metal tube with a metal foam liner comprising: providing a metal tube of desired characteristics; providing a metal foam liner of desired characteristics, the desired characteristics including the metal foam liner having an outer wall adapted to contact at least partially an inner wall of the metal tube; providing a mandrel adapted to contact and apply a slight compression onto an inner wall of the metal foam liner, an external surface of the mandrel being non-bonding with the metal foam liner; inserting the metal foam liner inside the metal tube to form a tube-liner assembly; inserting the mandrel inside the tube-liner assembly; applying radial compression onto the inner wall of the metal foam liner via the insertion of the mandrel into the tube-liner assembly; applying a heating treatment to the tube-liner assembly with the mandrel inserted therein to bond at least partially the outer wall of the metal liner to the inner wall of the metal tube; cooling down the tube-liner assembly with the mandrel inserted; and removing the mandrel from the metal tube-liner tube assembly.

Preferably, there is a non-bonding material on the external surface of the mandrel that is selected from the group consisting of: boron nitride, stainless steel, and graphite.

It is preferred that the mandrel be longer than the metal tube, and the method further comprises adjusting the mandrel in the tube-liner assembly so as to have ends of the mandrel extending on each side of the tube-metal liner assembly, before applying the heating treatment. The mandrel provides uniform applying radial compression onto the inner wall of the tube-liner assembly. Previously, in prior art metal tubes with sintered powder liners, the mandrel was secured at one end only, and the other end would be free to move and would create zones where the thickness of the sintered powder liner was not uniform. A uniform distribution of the thickness of the metal foam liner is desired for achieving greater results.

It is even more preferred that the ends of the mandrel be secured during the heating treatment Preferably, the heating treatment is done in a hydrogen nitrogen mixture atmosphere to hinder oxidation. Oxidation is generally undesirable as it produces a layer of copper oxide that alters the performance of the tube with liner. It is also possible to conduct the heating treatment in a vacuum.

The heating treatment may, for example, be done at 1050 degrees C. for 8 hours, and results in sintering the outer wall of the metal foam liner to the inner wall of the metal tube.

In some cases, the cooling down is done passively by leaving the tube-liner assembly in an environment at room temperature until the temperature of the tube-liner assembly comes down to the room temperature.

It may be that one or both of inserting the metal foam liner inside the metal tube, and inserting and removing the mandrel inside the tube-liner assembly, are done by sliding one or more of the metal liner, the metal tube and the mandrel with respect to one another.

In a preferred embodiment, the desired characteristics of the metal tube include the metal tube having an outer diameter of between 2 mm and 75 mm, a length of between 10 mm and 1000 mm, a wall thickness of between 0.2 mm and 2 mm, and the desired characteristics of the metal foam liner include a thickness of between 0.1 mm and 10 mm, a permeability of between 10⁻¹³ m² and 10⁻⁸ m², a capillarity radius of between 5 μm and 1 mm, a thermo-conductivity of between 1 W/m·K and 50 W/m·K, and porosity of between 40% and 90% void volume.

In a further aspect, as embodied and broadly described herein, the present invention provides a method of making a metal tube with a heterogeneous porous metal liner. In one embodiment, the heterogeneous metal porous liner is composed of a metal foam liner and a sintered powder liner. A length of the metal foam liner is shorter than the length of the metal tube, and powder metal particles are poured in between the mandrel and the inner wall of the metal tube where at least a portion of the metal tube is not lined with the metal foam liner, before the heating treatment. For some applications, it is preferred to process a metal tube with metal foam liner composed of more than one type of metal foam. The metal foam liner is a first metal foam liner, the length of the first metal foam liner is shorter than the length of the metal tube. The method further comprises inserting at least one second metal foam liner inside the metal tube after inserting the first metal foam liner inside the tube to form the tube-liner assembly, before the heating treatment. In other embodiments, the heterogeneous metal porous liner is composed of one or more metal foam liners having different properties and for one or more sintered powder liners having different properties.

It is preferred that for some applications, the heterogeneous porous metal liner has a non-uniform thickness, wherein portions of the thickness of the heterogeneous porous metal liner are associated with each liner composing the heterogeneous liner. To do so, the mandrel has a first portion and a second portion. The first portion has a first cross-section and a length of a length of the metal foam liner. The second portion has a second cross-section and a length of a length of the at least portion of the metal tube not lined with the metal foam liner. The first cross-section is different from the second cross-section.

It is also preferred for some applications that the metal foam liner is comprised of several metal foam liners. At least one second metal foam liner is inserted inside the metal tube after inserting the first metal foam liner inside the tube to form the tube-liner assembly, before inserting the mandrel in the tube-liner assembly.

In another aspect, the invention also provides a method for making a tube of metal foam comprising: providing a sheet of metal foam of desired characteristics and dimensions; providing a jig having a groove, the groove having at least a portion shaped and dimensioned to coincide with a shape and dimension of an outer surface of the tube of metal foam to be made; providing a cylindrical mandrel of a diameter substantially equal to an inner diameter of the tube of metal foam to be made; placing the sheet of metal foam onto the jig above the groove; placing the mandrel aligned with the groove on top of the sheet of metal foam; pressing the mandrel onto the sheet of metal foam into the groove, the pressing resulting in bending at least partially the sheet of metal foam; lifting the mandrel up; repeatedly placing remaining flat portions of the sheet of metal foam onto the jig above the groove, placing the mandrel aligned with the groove on top of the sheet of metal foam, and pressing the mandrel onto the sheet of metal foam into the groove, until the sheet of metal foam forms the tube of metal foam to be made; and removing the mandrel from the tube of metal foam once the tube of metal foam is made.

It is preferred that the method further comprises holding the metal sheet in place onto the jig, before pressing the mandrel onto the sheet of metal foam into the groove.

It is even more preferred that the groove is a semicircular-shaped longitudinal groove having a diameter substantially equal to an outer diameter of the tube of metal foam to be made.

In some cases, the groove is a second recess, and the jig further comprises a first recess. The first recess is used to constrain the sheet of metal foam to ease uniform rolling. The second recess is within the first recess, and the second recess being deeper than the first recess. The first recess has a width of at least a width of the sheet of metal foam. The first recess has at least one open end. The second recess is at an angle with respect to the at least one open end of the first recess. When the sheet of metal foam is placing onto the jig, the sheet of metal foam is placed into the first recess.

In some embodiments, the jig used for rolling the sheet of porous metal into a tube comprises a first recess having at least one open end. The first recess has a width adapted to be at least a width of the sheet of porous metal. A second recess is disposed within the first recess. The second recess is a groove having at least a portion adapted to coincide with an outer surface of the tube to be made. The second recess is deeper than the first recess. The second recess is at an angle with respect to the at least one open end of the first recess.

It is preferred that the second recess is perpendicular to the open end of the first recess.

It is preferred that, the desired characteristics include having a width of the metal foam sheet substantially equal to a perimeter of an outer cross-section of the desired tube of metal foam liner.

The term ‘metal foam’ refers to an open cell porous metallic structure having porosity higher than 50% void volume.

The term ‘seam’ refers to a line of junction between two surfaces or sections along their edges. The seam can be a ridge, a groove or a gap made by fitting, joining, or lapping together the two surfaces along their edges.

The term ‘substantially equal’ refers to a dimension that is equal or slightly larger or smaller than the quantity it is compared to, to the extent that it does not lead to unwanted material alterations that are incompatible with the intended use.

The term ‘heterogeneous’ refers to a system consisting of multiple items having distinct structural, physical and/or geometrical properties.

The term ‘heating treatment’ refers to a heating regiment selected to achieve the desire result. The heating regiment comprises one or more selected temperatures for several periods of time.

The term ‘porosity’ refers to the ratio of volume of void space in a porous material over the total or bulk volume of the porous material, including the solid and void components.

The term ‘void volume’ refers to the porosity times 100.

The term, ‘capillary radius’ refers to the capillary radius r_{BP} (m) given by the equation:

$${r}_{BP} = \frac{2 σ}{Δ {p}_{BP}} ,$$

where σ (N/m) is the surface tension of the fluid and Δp_{BP} (N/m²) is the pressure loss through the porous material. The capillary radius is measured using the method described in standard ASTM F316-03, which is generally known as the bubble point method for measuring the capillary radius.

The term ‘water permeability’ refers to the permeability Π (m²) given by the Darcy's law:

$$\frac{Δ p ( t )}{L} = - \frac{μ}{\prod } \frac{{D}_{1}^{2}}{{D}_{2}^{2}} v ( t ) + ρ C \frac{{D}_{1}^{4}}{{D}_{2}^{4}} {v ( t )}^{2}$$

where C (1/m) is the shape factor, μ (N·s/m²) the dynamic viscosity of the fluid, ρ (Kg/m³) the density of the fluid, ΔP is the applied pressure difference (N/m²), L the thickness of the porous medium (m), v is the superficial (or bulk) fluid flow velocity through the medium (i.e., the average velocity calculated as if the fluid were the only phase present in the porous medium) (m/s), D1 the inlet diameter of the permeability measuring apparatus, D2 the outlet diameter of the permeability measuring apparatus, and t the time.

The term ‘thermal conductivity’ refers to the metal foam bulk thermal conductivity (k in W/m·K). It is measured with an apparatus using principals similar to the Searle's bar method. In the measuring method of the present application, two identical blocks of a same porous material are placed on each side of a heat source. The heat source is made from a mica plate heater placed in between two bulk copper blocks. The bulk copper blocks are used to make sure the heat flux is uniform. The bulk copper blocks have the same lateral dimension as the two blocks of porous material to have adequate good contact. The other side of the two blocks of porous material are cooled down by a cold plate. The cold plate is a metal block with internal channels where cooling water circulates. The entire porous material blocks—heater—cold plates system is thermally insulated to prevent heat losses which would influence the thermal conductivity measurement. The thermal conductivity k is given by the equation: Q=−kA ((T2−T1)/t, where Q is the heat supplied by the mica heater to the foam blocks in time t, A is the cross-sectional area of the foam block, T1 is the temperature nearest the heated end, and T2 is the temperature measured a distance d away from the point of T1 measurement. The current apparatus is symmetrical as is it measures the average thermal conductivity of two blocks of the same porous material.

The term ‘heat resistance’ is the inverse of the thermal conductivity as measured on a heat pipe having the metal tube with metal porous liner under consideration, and the heat pipe having water as a working fluid.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a top perspective view of a first embodiment of a metal tube with porous metal liner;

FIG. 2 is a top perspective view of the metal tube of the metal tube with porous metal liner of FIG. 1;

FIG. 3 is a top perspective view of the porous metal liner of the metal tube with porous metal liner of FIG. 1;

FIG. 4 is a top perspective view of a second embodiment of the metal tube with porous metal liner;

FIG. 5 is a top perspective view of a third embodiment of the metal tube with porous metal liner;

FIG. 6 is a top perspective cross-sectional view of a fourth embodiment of the metal tube with porous metal liner;

FIG. 7 is a top perspective view of a jig used for rolling a sheet of metal foam to form a tube of metal foam;

FIG. 8 is a top perspective view of a sheet of metal foam used in conjunction with the jig of FIG. 7;

FIG. 9 is a graphic representation of a first step of a method of forming the tube of metal foam of FIG. 3 using the jig of FIG. 7 and the sheet of metal foam of FIG. 8;

FIG. 10 is a graphic representation of a second step of the method of forming the tube of metal foam of FIG. 3;

FIG. 11 is a graphic representation of a third step of the method of forming the tube of metal foam of FIG. 3;

FIG. 12 is a graphic representation of a fourth step of the method of forming the tube of metal foam of FIG. 3;

FIG. 13 is a graphic representation of a fifth step of the method of forming the tube of metal foam of FIG. 3;

FIG. 14 is a graphic representation of a sixth step of the method of forming the tube of metal foam of FIG. 3;

FIG. 15 is a perspective view of the tube of metal foam of FIG. 3 obtained using the method of FIGS. 9 to 14;

FIG. 16 is flow chart of a method of making the metal tube with porous liner of FIG. 1;

FIG. 17 is a perspective view of the metal tube of FIG. 2 and the metal foam liner of FIG. 3;

FIG. 18 is a perspective view of the metal tube and porous metal liner of FIG. 17 forming a tube-liner assembly and shown with a mandrel;

FIG. 19 is a same view as FIG. 18 shown with the mandrel inserted into the tube-liner assembly;

FIG. 20 is a perspective view of the tube-liner assembly FIG. 19 shown with the tube-liner assembly partially cut away to reveal the mandrel, the metal foam liner, and the metal tube;

FIG. 21 is flow chart of a method for making the fourth embodiment of the metal tube with porous metal liner of FIG. 6;

FIG. 22 is a perspective cross-sectional view of the mandrel inserted into the fourth embodiment of the metal tube with porous metal liner of FIG. 6 shown with a portion of the porous liner removed to reveal a section of the metal tube;

FIG. 23 is a same view as FIG. 22 shown with the entire porous liner;

FIG. 24 is a same view as FIG. 23 shown with the mandrel partially removed from the metal tube with porous metal liner;

FIG. 25 is a perspective cross-sectional view of another mandrel inserted into a fifth embodiment of the metal tube with metal porous liner shown with a portion of the porous liner removed to reveal a section of the metal tube;

FIG. 26 is a same view as FIG. 25 shown with the entire porous liner; and

FIG. 27 is a same view as FIG. 26 shown with the other mandrel partially removed from the metal tube with metal porous liner.

### DETAILED DESCRIPTION OF THE PREFERRED EMBODIMENTS

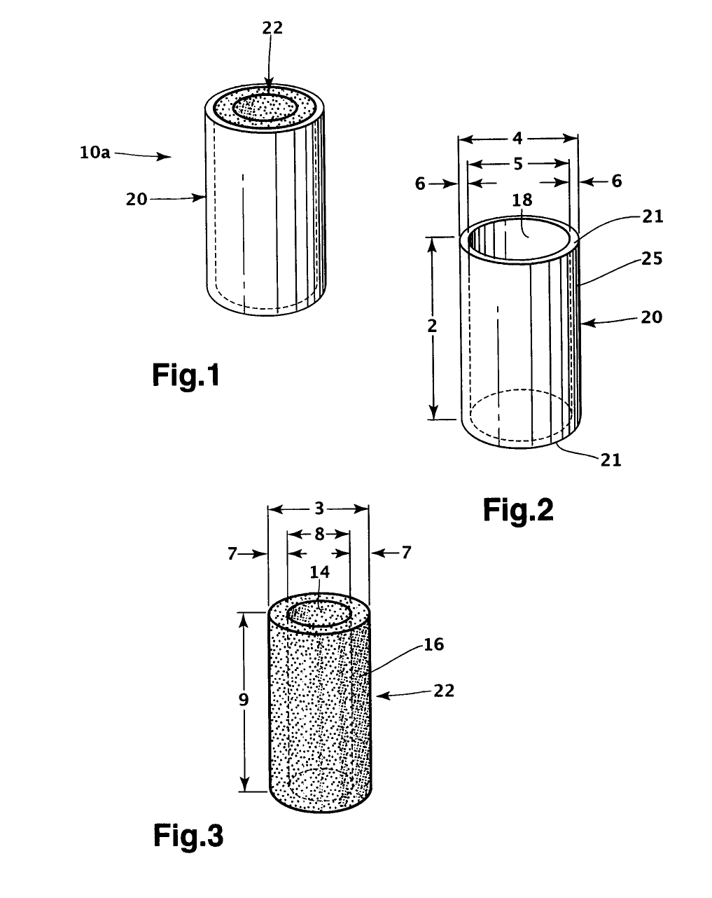

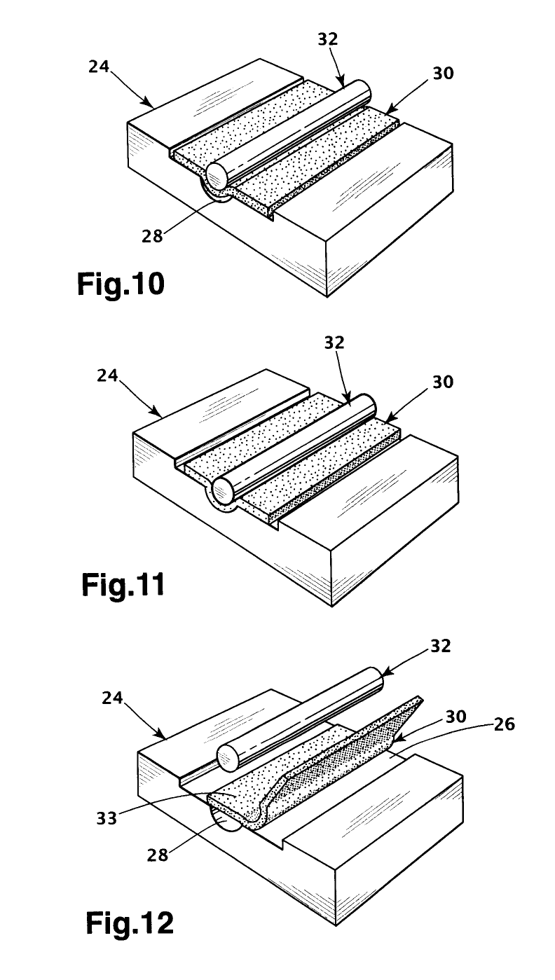

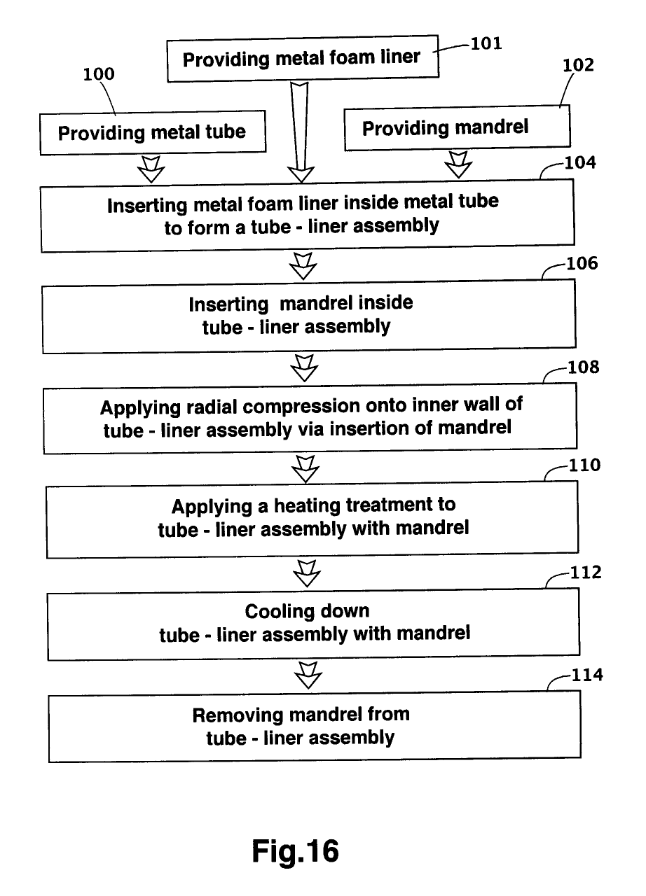

With respect to FIGS. 1 to 3, a first embodiment of a metal tube with porous metal liner 10a will now be described. The metal tube with porous metal liner 10a (shown in FIG. 1) is a straight circular metal tube 20 having an inner wall 18 lined with a straight cylindrical metal foam liner 22. A method of obtaining such a tubular liner from a sheet of metal foam 30 will be described in greater detail below with reference to FIGS. 9 to 15. The metal foam liner 22 is metallurgically bonded in thermo-conduction with the metal tube 20. A method for making the metal tube with porous metal liner 10a will be described in greater detail below with reference to FIGS. 16 to 20.

As best seen in FIG. 2, the metal tube 20 has two open ends 21. It is contemplated that, for some applications, one end 21 would be closed (not shown), partially or totally. The metal tube 20 is made by extrusion and as a result has no seam. Although it is preferable that the metal tube 20 has no seam for applications such as heat pipes, it is contemplated that the metal tube 20 could have a seam for applications where a seam is not incompatible with subsequent manufacturing steps or the intended use of the final product. The seam might be the result of fabricating the metal tube 20 using rolling of a metal sheet into a tube (similarly to what is shown in FIGS. 9 to 15 for a sheet of metal foam 30). The rolling could result in longitudinal edges of the metal sheet abutting or overlapping. In those cases non-limiting examples of seam are: a longitudinal extrusion or intrusion, or a line created by abutting or almost abutting edges of the metal sheet. Where the metal tube 20 has an internal seam, lining of the metal foam liner 22 may be adapted to accommodate the seam, again, where not incompatible with subsequent manufacturing steps or the intended use of the final product.

The metal tube 20 is made of copper. It is contemplated that, in other embodiments, metallic particles, metallic alloy and/or a combination thereof having at least one transition metal, and preferably at least one transition metal selected from the group consisting of scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, and gold could be also used for making the metal tube 20.

The metal tube 20 has a length 2 of 300 mm, an outer diameter 4 of 6 mm, a wall thickness of 0.3 mm. It is contemplated that the length 2 could be of between 50 mm and 1000 mm, the outer diameter 4 of between 4 mm and 50 mm, and the wall thickness 6 of between 0.2 mm and 2 mm. The metal tube 20 is a straight tube having a constant circular cross-section. It is contemplated that, for certain applications, the metal tube 12 would have small or gradual variations of the cross-section. The metal tube 20 could alternatively have a slight radius of curvature. It is also contemplated that, for certain applications, the cross-section would not be circular.

As best seen in FIG. 3, the metal foam liner 22 is a tube of metal foam wherein the metal foam is described in the International Patent Application Publication No. WO 2009/049427 published Apr. 23, 2009 entitled “Open Cell Porous Material, and a Method of and Mixture of Making Same”, the entirety of which is incorporated herein by reference. It is contemplated that, depending on the application, the metal foam of the metal foam liner 22 would alternatively be one of the metal foams described in the '224 and the '828 patents. It is also contemplated that the metal foam of the metal foam liner 22 could be the one described in the International Patent Application Publication No. WO 2007/112554 published on Oct. 11, 2007 entitled “Method For Partially Coating Open Cell Porous Materials”. Such metal foam is preferred when the bonding is done by brazing.

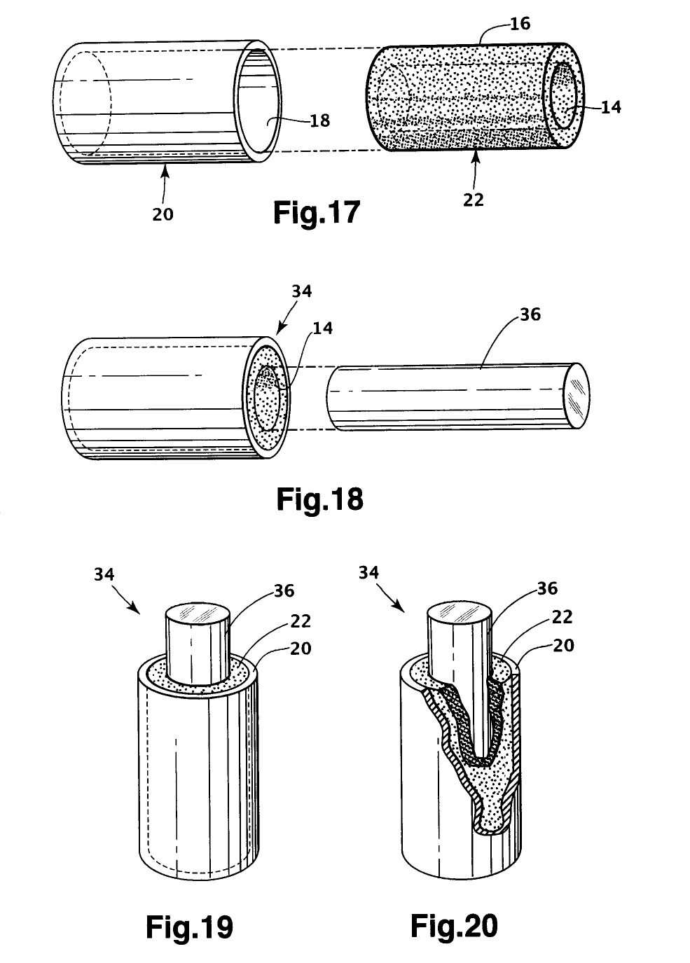

The metal foam liner 22 is designed to have an outer wall 16 contacting with the inner wall 18 of the metal tube 20 (as best shown in FIG. 17). As a consequence, the metal foam liner 22 has an outer diameter 3 substantially equal to an inner diameter 5 of the metal tube 20. The metal foam liner 22 has a length 9 equal to the length 2 of the metal tube 20. It is contemplated that, for certain applications, the metal foam liner 22 would have the length 9 greater or smaller than the length 2. The metal foam liner 22 has a thickness 7 of 0.7 mm. It is contemplated that, for certain applications, the thickness 7 could be of between 0.1 mm and 10 mm. The thickness 7 of the metal foam liner 22 and the dimensions of the metal tube 20 are chosen depending on the application for which the metal tube with porous metal liner 10a is intended.

The metal foam liner 22 is made of copper. It is contemplated that, for certain applications, the metal foam liner 22 would be made of the same other materials as recited above with respect to the metal tube 20. It is also contemplated that, for other applications, the metal foam liner 22 and the metal tube 20 would not be made of the same material depending on the application they are intended to be used for.

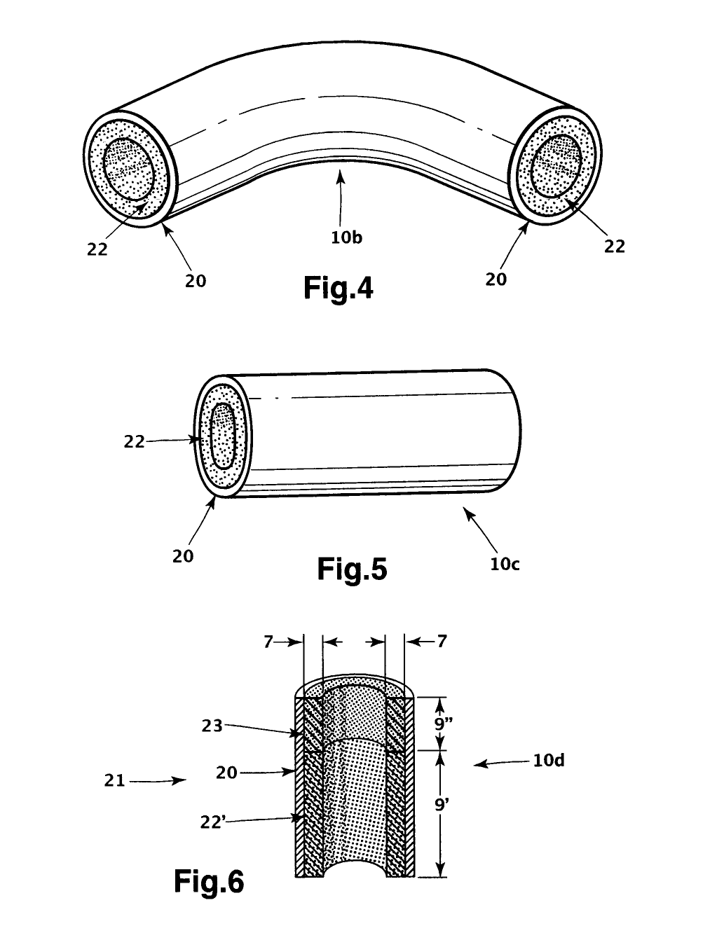

In a second embodiment of a metal tube with porous metal liner 10b, shown in FIG. 4, the metal tube 20 and metal foam liner 22 are curved and form a curved metal tube with porous metal liner 10b. To obtain such a curved metal tube with porous metal liner 10b, one curves with conventional techniques the metal tube with porous metal liner 10b after the metal foam liner 22 has been inserted into and bonded to the metal tube 20. It is also possible to curve the metal tube with porous metal liner 10b after it has been transformed into a heat pipe.

In a third embodiment of a metal tube with porous metal liner 10c, shown in FIG. 5, the metal tube with porous metal liner 10c has a flattened profile. To obtain such a flattened metal tube with porous metal liner 10c, one flattens with conventional techniques the metal tube with porous metal liner 10c after the metal foam liner 22 has been inserted into and bonded to the metal tube 20. It is also possible to flatten the metal tube with porous metal liner 10c after it has been transformed into a heat pipe.

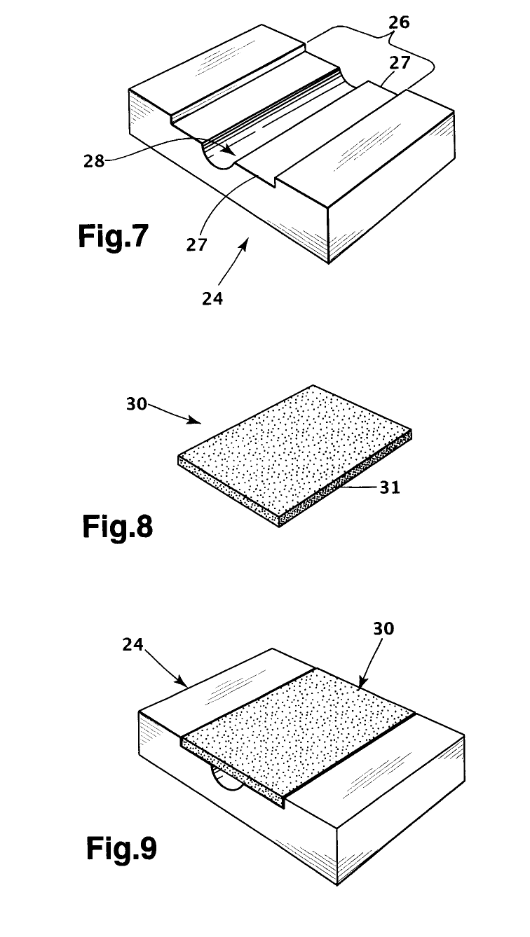

In a fourth embodiment of a metal tube with porous metal liner 10d, shown in FIG. 6, the metal tube 20 is lined with a heterogeneous porous metal liner 21. The heterogeneous porous metal liner 21 is composed of a sintered powder liner 23 disposed adjacent to a metal foam liner 22′ along the length 2 of the metal tube 20. The metal tube with porous metal liner 10d has elements common with the metal tube with porous metal liner 10a (nature and size of the metal tube 20, nature and size of the metal foam liner 22 being the metal foam liner 22′) except a length 9′ of the metal foam liner 22′ is shorter than the length 9 of the metal foam liner 22. These common elements will not be repeated.

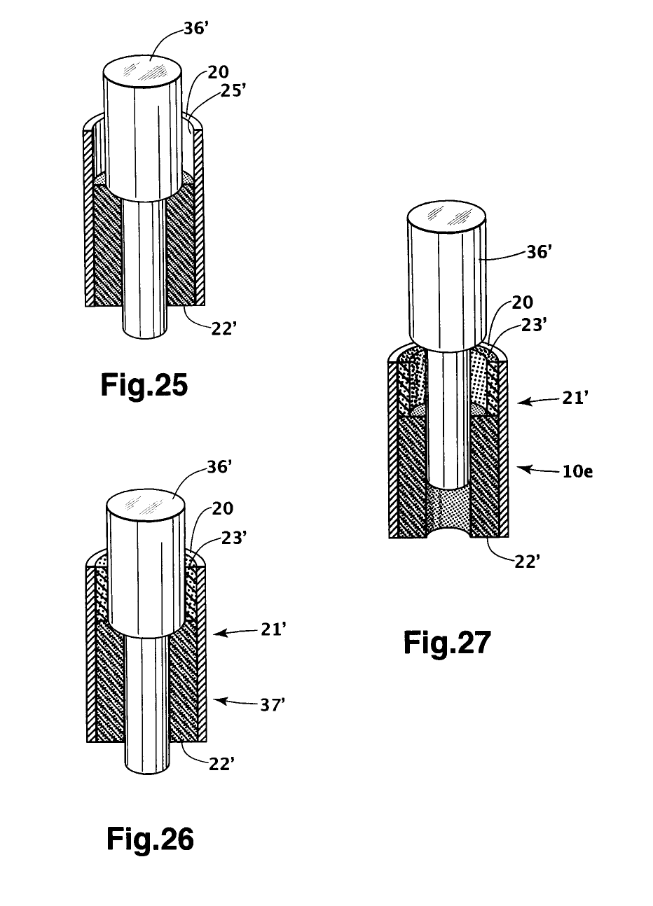

The sintered powder liner 23 lines a portion of the inner wall 18 of the metal tube 20 that is free from metal foam liner 22′. It is contemplated that, for certain applications, the sintered powder liner 23 would line only a portion of the inner wall 18 that is free from metal foam liner 22′. It is also contemplated that, for certain applications, more than one sintered powder liner 23, and more than one metal foam liners 22′ would be used to form the heterogeneous porous metal liner 21. It is also contemplated that, in some cases, the heterogeneous porous metal liner 21 would be made only of metal foams having different properties. The sintered powder liner 23 is of a same thickness as the thickness 7 the metal foam liner 22′. It is contemplated that, for certain applications, the sintered powder liner 23 would be thinner than the metal foam liner 22′ (such as shown in FIGS. 25 and 26) or thicker than the metal foam liner 22′.

The sintered powder liner 23 and the metal foam liner 22′ have sizes and properties adapted for the application they are intended to be used for. In the application for cooling a CPU for example, the sintered powder liner 23 is designed to be located above the CPU and the metal foam liner 22′ is designed to be located in the adiabatic and condenser sections of a heat pipe to be created from the tune-liner assembly. In the fourth embodiment of the metal tube with porous metal liner 10d, shown in FIG. 6, a length 9″ of the sintered powder liner 23 is shorter than the length 9′ of the metal foam liner 22′. The length 9″ is selected so as to correspond to a length of the CPU, and the length 9′ is selected so as to correspond to a length of the adiabatic and condenser sections. More specifically, the length 2 of metal tube 20 is 300 mm, the length 9′ of the metal foam liner 22′ is 250 mm, and the length 9″ of the sintered powder liner 23 of 50 mm. It is contemplated that, for certain applications, the sintered powder liner 23 would be longer or of the same length as the metal foam liner 22′. A heat resistance of the metal tube with porous metal liner 10d at a location of the metal foam liner 22′ is of about 0.5° C./W, and a heat resistance of the metal tube with porous metal liner 10d at a location of the sintered powder liner 23 is of about 0.3° C./W at 35 W.

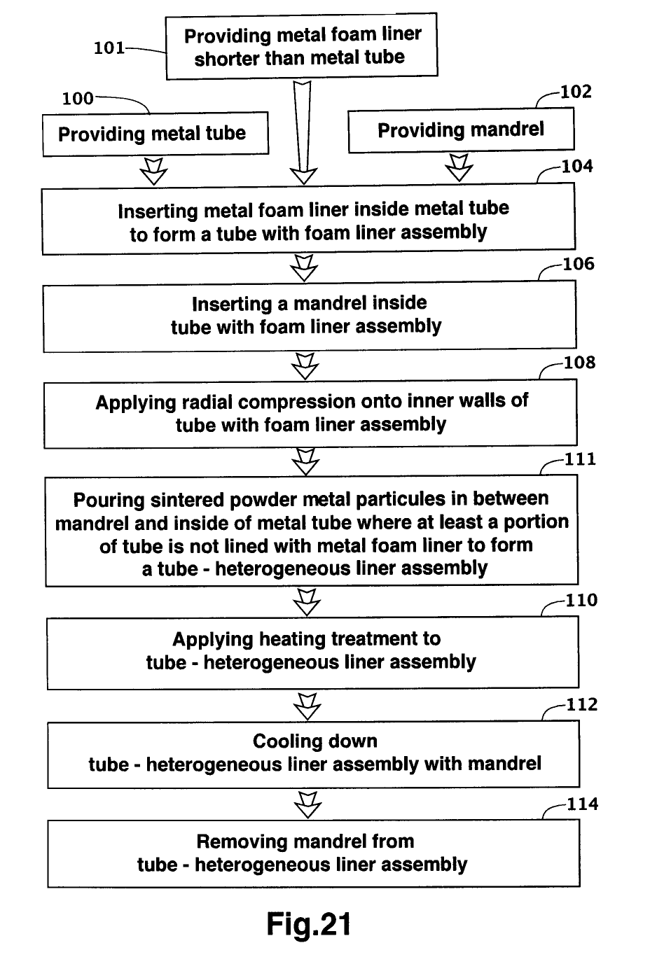

The inner diameter 8 of the meal foam liner 22′ and the sintered powder liner 23 is of 4 mm, and the thickness 7 of the meal foam liner 22′ and the sintered powder liner 23 is of 0.7 mm. The sintered powder liner 23 has a porosity of between 45% to 55% void volume. The sintered powder liner 23 is made of the same material (copper) as the metal foam liner 22 and the metal tube 20. It is contemplated that, for certain applications, the metal foam liner 22, the sintered powder liner 23, and the metal tube 20 would all be made of different materials than copper, and would have each a different material. A method for producing the metal tube with porous metal liner 10d wherein the liner is heterogeneous is described below with reference to FIGS. 21 to 27.

Turning now to FIGS. 7 to 15, a method of forming a tube of metal foam, namely the metal foam liner 22, from a sheet of metal foam 30, will be described. The tube of metal foam 22 can be subsequently used for making the metal tube with porous metal liner 10a, for which a making is described below with respect to FIGS. 16 to 20. The sheet of metal foam 30 (shown in FIG. 8) has to undergo a plastic deformation to be rolled into a tube. A jig 24 (shown in FIG. 7) and a rolling mandrel 32 (shown in FIG. 9) are used to accomplish rolling of the sheet of metal foam 30 into the tube of metal foam 22. The jig 24 is made out of stainless steel. It is contemplated that, for certain applications, other suitable materials commonly used in the field, would be used. The jig 24 has a first recess 26, and a second recess 28 within the first recess 26.

The first recess 26 is dimensioned for receiving the sheet of metal foam 30 and for constraining movement of the sheet of metal foam 30 during rolling. It is possible that during rolling, the sheet of metal foam 30 slides on the jig 24. Sliding is unfavourable because it could lead to improper rolling of the sheet of metal foam 30. The first recess 26 has at least a length and a width substantially equal to the length and the width of the sheet of metal foam 30. The first recess 26 has two open ends 27 (shown in FIG. 7). It is contemplated that the first recess 26 could be omitted. It is also contemplated that the first recess 26 could have only one open end 27, or more than two ends 27. It is also contemplated, that other techniques for holding the sheet of metal foam 30 in place could be used in addition to or instead of the first recess 26.

The second recess 28 is a semicircular-shaped longitudinal groove perpendicular to the two open sides 27 of the first recess 26. It is contemplated that the second recess 28 could be at an angle other than perpendicular with respect to the two open sides 27 of the first recess 26. The second recess 28 has a cross-section of a diameter substantially equal to an outer diameter of the tube of metal foam 22 to be made. It is also contemplated that, for certain applications, the second recess 28 would be only a portion of a circle or would have a non constant radius of curvature.

The rolling mandrel 32 is used to bend and curve a portion of the metal sheet 30 at the second recess 28. The rolling mandrel 32 is a cylindrical rod having an exterior surface of stainless steel and a diameter of substantially the inner diameter 8 of the tube of metal foam 22 to be made. It is contemplated that, for certain applications, the rolling mandrel 32 would have a different shape, depending on the shape of the tube of metal foam 22 to be made. For example, the cross-section could be an oval cross-section. It is also contemplated that, for some other applications, the rolling mandrel 32 would not have a shape coinciding with a shape of the second recess 28. It is contemplated that, for certain applications, the rolling mandrel 32 would have an external surface of material other than stainless steel.

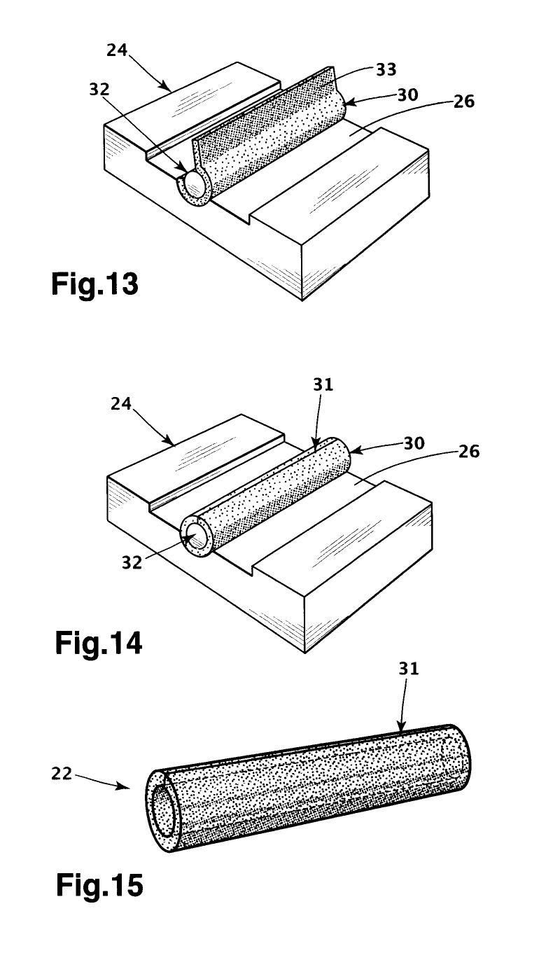

The method starts with providing the metal foam sheet 30 of desired characteristics and dimensions (FIG. 8). The desired characteristics include having a width of the metal foam sheet 30 equal to a perimeter of the outer cross-section of the desired tube of metal foam liner 22. If the sheet of metal foam 30 is too big or too thick, it is possible to resize it by cutting, for example. The sheet of metal foam 30 is placed on the first recess 26 (FIG. 9). The rolling mandrel 32 is placed aligned with the second recess 28 onto of the metal foam sheet 30 (FIG. 10). Once positioned, the rolling mandrel 32 is pressed onto the sheet of metal foam 30 into the second recess 28 (FIG. 11). The pressing results in bending the sheet of metal foam 30 into the shape of the semicircular longitudinal groove of the second recess 28. Once the bending is done, the rolling mandrel 32 is lifted up. The sheet of metal foam 30 is lifted, and a remaining flat longitudinal portion 33 of the sheet of metal foam 30 is selected for bending. The remaining flat longitudinal portion 33 is placed on the first recess 26 at a location of the second recess 28 (FIG. 12). The rolling mandrel 32 is placed aligned with the second recess 28 on top of the remaining flat longitudinal portion 33 of the metal foam sheet 30. The rolling mandrel 32 is pressed onto the remaining flat longitudinal portion 33 into the second recess 28 (FIG. 13), resulting in the bending of the remaining flat longitudinal portion 33. The operation consisting of placing remaining flat longitudinal portions of the metal foam sheet 30 above the second recess 28 and pressing the rolling mandrel 32 onto remaining flat longitudinal portions 33 into the second recess 28 is repeated until the metal foam sheet 30 has the shape of the tube of metal foam 22 to be made (FIG. 14). Once the tubular metal foam liner 22 is shaped, the rolling mandrel 32 is removed (slid out) from the metal foam 22. The end result is a tubular metal foam liner 22 having contacting face-to-face ends 31 (FIG. 15). It is contemplated that, for certain applications, the ends 31 would overlap, and for other applications, the ends 31 would not contact. To do so, the desired characteristics of the second recess 28, the rolling mandrel 32 and the size of the sheet of metal foam 30 would be adjusted. The above method of forming a tube of metal foam is carried on manually, but it is contemplated that all or some of the above steps could be automated.

Turning now to FIGS. 16 to 20, a method for making the metal tube with porous metal liner 10a will be described. Referring more specifically to FIG. 16, the method starts with providing a metal tube 20 (step 100), a tubular porous liner 22 (step 101), and a compression mandrel 36 (step 102), all of desired characteristics. The desired characteristics are chosen so that when in place inside the metal tube 20, the outer wall 16 of the metal foam liner 22 contacts at least partially the inner wall 18 of the metal tube 20, an external surface of the compression mandrel 36 contacts the inner wall 14 of the metal foam liner 22, and the thickness 7 of the metal foam liner 22 is uniform. The tubular porous liner 22 is obtained from the rolling of the sheet of metal foam 30, as described above, but it is contemplated that, for certain applications, other techniques would be used.

A first step of the method is to form a non bonded tube-liner assembly 34. To do so, the metal foam liner 22 is inserted inside the metal tube 20 (step 104). The metal tube 20 is free of burrs in order to facilitate the operation. It is contemplated that the metal tube 20 could not be free of burrs. The insertion is done by sliding the tube of metal foam liner 22 inside the metal tube 20 without undue efforts (i.e. without deforming or breaking the metal foam liner 22). Once the tube-liner assembly 34 is formed, the compression mandrel 36 is inserted inside the tube-liner assembly 34 (step 106).

The compression mandrel 36 is a cylindrical rod having an external surface of a material that is non-bonding with the metal foam liner 22. The compression mandrel 36 is non-bonding to facilitate its extraction at the end of the method. It is contemplated that the compression mandrel 36 could have some stickiness. However, as long as it is removable at the end of the method without undue effort or damaging the end product. The compression mandrel 36 is coated of Boron-Nitride. It is contemplated that the compression mandrel 36 could be coated of other types of non-bonding materials. For example, depending on the application, the compression mandrel 36 is made of steel, stainless steel, or nickel. It is also contemplated that the whole compression mandrel 36 could be made of the non-bonding material. For example, the compression mandrel 36 could be made entirely of graphite and as such, would not require any coating. The compression mandrel 36 is longer than the length 2 of the non-bonding material to facilitate manipulation. It is contemplated that, for certain applications, the compression mandrel 36 would be shorter than or of the same length as the tube-liner assembly 34 for bonding only selected portions of the metal liner 22 to the inner wall 18 of the metal tube 20. The purpose of the compression mandrel 36 is first to hold the metal foam liner 22 against the inner wall 18 of the metal tube 20, and second, to apply a radial compression onto an inner wall of the tube-liner assembly 34 (i.e. onto the inner wall 14 of the metal foam liner 22). The compression mandrel 36 has a diameter slightly larger than an inner diameter of the tube-liner assembly 34 (i.e. the inner diameter 8 of the metal foam liner 22). By ‘slightly’, one should understand the same or a larger diameter to the extent that it does not undesirably structurally alter the metal foam liner 22. Therefore, the diameter of the compression mandrel 36 should not be that much larger than the inner diameter of the tube-liner assembly 34, otherwise too high a compression will be induced on the inner wall 14 of the tube-liner assembly 34, and will result in a squeezing of the metal foam liner 22 against the inner wall 18 of the metal tube 20, which in turn will affect the porosity of the metal foam liner 22. The diameter of the compression mandrel 36 should also not be that much smaller than the inner diameter 8 of the tube-liner assembly 34, otherwise not enough compression will be induced on the tube-liner assembly 34, resulting in improper bonding of the metal foam liner 22 onto the inner wall 18 of the metal tube 20. As an example, if the tube-liner assembly 34 has an inner diameter of 3.8 mm, the compression mandrel 36 could have a diameter of 4 mm. The compression typically represents between 5 and 10% reduction of the thickness 7 of the metal foam liner 22. It is contemplated that, for certain applications, the compression mandrel 36 would have a non uniform cross-section, and that the compression would vary along the length 2 of the metal tube 20.

The compression mandrel 36 is positioned to have ends extending from each end of the tube-liner assembly 34. The position of the compression mandrel 36 is further adjusted radially to provide a uniform distribution of the compression to the inner wall of the tube-liner assembly 34. It is contemplated that this step could be omitted. Once the compression mandrel 36 inserted into the tube-liner assembly 34, the inner wall of the tube-liner assembly 34 is under the slight compression (step 108). A heating treatment is applied to the tube-liner assembly 34 with the compression mandrel 36 inserted therein in order to bond the metal foam liner 22 to the metal tube 20 by sintering (step 110). It is contemplated that, for certain applications, the heating treatment would bond the metal foam liner 22 to the inner wall 18 of the metal tube 20 by brazing. It is also contemplated that the heating treatment could bond only a portion of the metal foam liner 22 to the metal tube 20. The compression mandrel 36 is left unsecured in the tube-liner assembly 34 during the heating treatment. It is contemplated that, for certain applications, one or two ends of the compression mandrel 36 would be held fixed during the heating treatment to further control the compression, and in turn to control the thickness 7 of the porous metal liner 22.

The heating treatment consists in heating the tube-liner assembly 34 with the compression mandrel 36 inserted therein for 8 hours at 1050 degrees C. The heating treatment causes the outer wall 16 of the metal foam liner 22 to create metallurgical bonds in thermal communication with the inner wall 18 of the metal tube 20, without causing the metal foam liner 22 to lose its porous properties. The heating treatment may comprise additional steps in order to bond the metal foam liner 22 to the inner wall 18 of the metal tube 20. The heating treatment is carried out in a hydrogen or hydrogen-nitrogen atmosphere. It is contemplated that the heating treatment could alternatively be not carried out in a hydrogen or hydrogen-nitrogen atmosphere. For example, the heating treatment could be carried in a vacuum. It is contemplated that the heating treatment could be shorter or longer and that a different temperature or a succession of different temperatures could be used.

Once the metal foam liner 22 is bonded to the inner wall 18 of the metal tube 20, the tube-liner assembly 34 with the compression mandrel 36 inserted therein is left to passively cool down to room temperature (step 112). It is contemplated that the tube-liner assembly 34 with the compression mandrel 36 inserted therein could be actively cooled down by techniques known in the art. Once cooled down, the metal foam liner 22 has bonded to the metal tube 20 to form the tube with metal liner 10a, and the compression mandrel 36 is removed from the tube with metal liner 10a (step 114).

The above method is carried on manually, but it is contemplated that all or some of the above steps could be automated.

Turning now to FIGS. 21 to 27, a method of producing a metal tube with hybrid or heterogeneous metal liner will be described.

With reference to FIGS. 21-24, a method of producing the metal tube with heterogeneous metal liner 10d having the heterogeneous porous metal liner 21 will now be described.

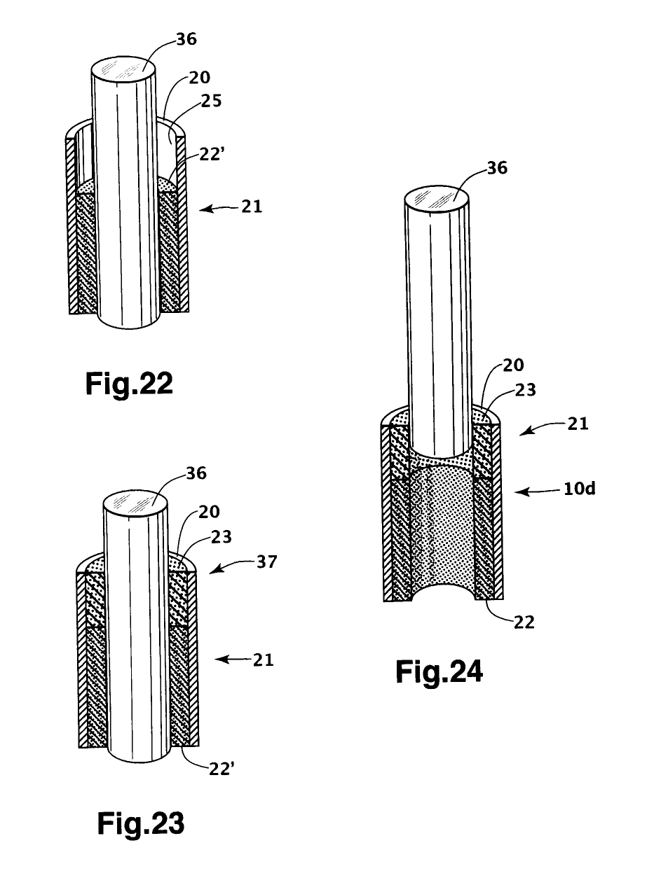

The metal tube with heterogeneous metal liner 10d has been described above with respect to FIG. 6. The method has steps 100, 101, 102, 104, 106, 108 similar to the method of producing a metal tube with porous metal liner 10a described above. These steps will therefore not be repeated. At the end of step 106, the metal foam liner 22′ and the compression mandrel 36 are inserted into the metal tube 20. At step 111, powder metal particles are poured into a space 25 (shown in FIG. 22) left between the compression mandrel 36 and the inner wall 18 of the metal tube 20 where the metal tube 20 is not lined with the metal foam liner 22. A tube-heterogeneous liner assembly 37 is formed (shown in FIG. 23). The following steps are similar to the method described above with respect to the metal tube with porous metal liner 10a and consist of heating (step 110), cooling down (step 112) and removing the compression mandrel 36 from the bonded tube with heterogeneous metal liner 10d (step 114). The end result is the heterogeneous porous metal liner 21 being bonded in thermal conduction to the inner wall 18 of the metal tube 20, so as to form the metal tube with heterogeneous metal liner 10d. It is contemplated that the heterogeneous porous metal liner 21 could be only partially bonded at the end of the method.

Referring in particular to FIGS. 25 to 27, a second embodiment of a metal tube with heterogeneous metal liner 10e will be described.

The heterogeneous porous metal liner 21′ is formed by a sintered powder liner 23′ and the metal foam liner 22′. The sintered powder liner 23′ is similar to the sintered powder 23 but has a smaller thickness, resulting in the sintered powder liner 23′ and the metal foam liner 22′ having different thicknesses. The difference of thicknesses is achieved using a compression mandrel 36′ having a stepped cross-section along its length. A cross-section of the compression mandrel 36′ is larger at the location where the sintered powder is poured, and cross-section of the compression mandrel 36′ is smaller at the location of the metal foam. The powder metal particles are poured in a space 25′ (shown in FIG. 25) formed between the compression mandrel 36′ and the inner wall 18 of the metal tube 20 that is free of metal foam liner 22′, after the metal foam liner 22 is inserted in the metal tube 20. The larger cross-section of the compression mandrel 36′ is chosen to be at the sintered powder liner 23′, so that removal of the compression mandrel 36′ is possible without damaging the metal foam liner 22′. It is contemplated that instead of a single compression mandrel 36′ having different cross sections, one could use two compression mandrels 36, each having a constant cross-section. The compression mandrels 36 would each be removed from a corresponding end of the metal tube with heterogeneous metal liner 10e. It is also contemplated that the compression mandrel 36′ could have a continuously variable cross-section, and that the sintered powder liner 23′ could be one or more sintered powder liners and one or more metal foam liners having some or all different thicknesses.

It is contemplated that, for certain applications, one would design a heterogeneous porous metal liner 21 where the sintered powder section 23 is thinner than the metal foam liner 22 by using another set of two compression mandrels 36. Each compression mandrel 36 would have a diameter for contacting with its corresponding sintered powder liner 23 and metal foam liner 22. It is also contemplated that, for certain applications, one would use the two compression mandrels 36 one at a time and would perform separate heating treatments for bonding the sintered powder liner 23 and the metal foam liner 22 independently.

The method of producing the metal tube with heterogeneous metal liner 10e having the heterogeneous porous metal liner 21′ is similar to the method of producing the metal tube with heterogeneous metal liner 10d described above. Details of the method will therefore not be repeated.

At step 111, powder metal particles are poured into the space 25′. A tube-heterogeneous liner assembly 37′ is formed (shown in FIG. 27). The metal tube with porous metal liner 10e is heated (step 110), cooled down (step 112) and the compression mandrel 36′ is removed from the bonded tube with heterogeneous metal liner 10d (step 114). The end result is the heterogeneous porous metal liner 21′ being bonded in thermal conduction to the inner wall 18 of the metal tube 20 to form the metal tube with heterogeneous metal liner 10e.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A metal tube with metal foam liner for use in making a heat pipe, the metal tube with metal foam liner comprising:
a metal tube having an inner wall and an outer wall, and at least one open end, the metal tube having an outer diameter of between 2 mm and 75 mm, the metal tube having a length of between 10 mm and 1000 mm, and the metal tube having a wall thickness of between 0.2 mm and 2 mm; and
a metal foam liner lining at least partially the inner wall of the metal tube, at least a portion of an outer wall of the metal foam liner being thermo-conductively bonded to the inner wall of the metal tube, the metal foam liner having a thickness of between 0.1 mm and 10 mm, the metal foam liner having a permeability of between 10⁻¹³ m² and 10⁻⁸ m², the metal foam liner having a capillarity radius of between 5 μm and 1 mm, and the metal foam liner having a thermo-conductivity of between 1 W/m·K and 50 W/m·K.

2. The metal tube with metal foam liner of claim 1, wherein at least the portion of the outer wall of the metal foam liner thermo-conductively bonded to the inner wall of the metal tube is metallurgicaly bonded to the inner wall of the metal tube.

3. The metal tube with metal foam liner of any one of claims 1 to 2, wherein the outer diameter of the metal tube is of between 3 mm and 50 mm.

4. The metal tube with metal foam liner of any one of claims 1 to 3, wherein the outer diameter of the metal tube is of between 4 mm and 50 mm.

5. The metal tube with metal foam liner of any one of claims 1 to 4, wherein the length of the metal tube is of between 50 mm and 1000 mm.

6. The metal tube with metal foam liner of any one of claims 1 to 5, wherein the permeability of the metal foam liner is of between 10⁻¹² m² and 10⁻⁹ m².

7. The metal tube with metal foam liner of any one of claims 1 to 6, wherein the permeability of the metal foam liner is of between 10⁻¹¹ m² and 10⁻⁹ m².

8. The metal tube with metal foam liner of any one of claims 1 to 7, wherein the capillary radius of the metal foam liner is of between 10 μM and 500 μm.

9. The metal tube with metal foam liner of any one of claims 1 to 8, wherein the capillary radius of the metal foam liner is of between 20 μm and 250 μm.

10. The metal tube with metal foam liner of any one of claims 1 to 9, wherein the thermo-conductivity of the metal foam liner is of between 3 W/m·K and 30 W/m·K.

11. The metal tube with metal foam liner of any one of claims 1 to 10, wherein the thermo-conductivity of the metal foam liner is of between 5 W/m·K and 30 W/m·K.

12. The metal tube with metal foam liner of any one of claims 1 to 10, wherein the thermo-conductivity of the metal foam liner is of between 4 W/m·K and 20 W/m·K.

13. The metal tube with metal foam liner of any one of claims 1 to 12, wherein the metal foam liner has a first pore group and a second pore group; the first pore group has an average pore size of between about 20 μm and about 200 μm; and the second pore group has an average pore size of between about 250 nm and about 40 μm.

14. The metal tube with metal foam liner of claim 13, wherein the second pore group has an average pore size of between about 250 nm and about 15 μm.

15. The metal tube with metal foam liner of any one of claims 13 to 14, wherein the first pore size group is of between about 40% and about 80% void volume, and the second pore size group is of between about 20% and about 50% void volume.

16. The metal tube with metal foam liner of claim of any one of claims 13 to 15, wherein the first pore size group is of between about 50% and about 80% void volume.

17. The metal tube with metal foam liner of one of claims 13 to 16, wherein the average pore size of the first pore group is of between about 40 μm and about 150 μm, and the average pore size of the second pore group is of between about 500 nm and about 30 μm.

18. The metal tube with metal foam liner of any one of claims 13 to 17, wherein the average pore size of the first pore group is of between about 60 μm and about 100 μm, and the average pore size of the second pore group is of between about 500 nm and about 20 μm.

19. The metal tube with metal foam liner of claim any one of claims 13 to 18, wherein the average pore size of the second pore group is of between about 500 nm and about 15 μm.

20. The metal tube with metal foam liner of any one of claims 13 to 19, wherein the average pore size of the second pore group is of between about 500 nm and about 10 μm.

21. The metal tube with metal foam liner of claims 13 to 20, wherein the metal foam liner further comprises a third pore group; and
the third pore group has an average pore size of between about 100 μm and about 1 mm.

22. The metal tube with metal foam liner of any one of claims 1 to 21, wherein the metal foam liner and the metal tube are each made of at least one of a material selected from the group constituted consisting of: metallic particles, metallic alloy and/or a combination thereof having at least one transition metal.

23. The metal tube with metal foam liner of claim 22, wherein the metal foam liner and the metal tube are each made of one or more materials selected from the group constituted consisting of: scandium, titanium, vanadium, chromium, manganese, iron, cobalt, nickel, copper, yttrium, zirconium, niobium, molybdenum, ruthenium, rhodium, palladium, silver, hafnium, tantalum, tungsten, rhenium, osmium, iridium, platinum, and gold.

24. The metal tube with metal foam liner of claim 23, wherein, the metal foam liner and the metal tube are each made of one or more materials selected from the group consisting of: copper, titanium, nickel, aluminum, steel, stainless steel, and silver.

25. The metal tube with metal foam liner of any one of claims 1 to 24, wherein the metal foam liner and the metal tube are made of a same material.

26. The metal tube with metal foam liner of claim 25, wherein the metal foam liner and the metal tube are each made of copper.

27. The metal tube with metal foam liner of any one of claims 1 to 26, wherein a porosity of the metal foam liner is of between 40% and 90% void volume.

28. The metal tube with metal foam liner of any one of claims 1 to 27, wherein a porosity of the metal foam liner is of between 50% and 85% void volume.

29. The metal tube with metal foam liner of any one of claims 1 to 28, wherein a porosity of the metal foam liner is of between 50% and 82% void volume.

30. The metal tube with metal foam liner of any one of claims 1 to 29, wherein a porosity of the metal foam liner is of between 50% and 80% void volume.

31. The metal tube with metal foam liner of any one of claims 1 to 30, wherein the outer wall of the metal foam liner is thermo-conductively bonded to the inner wall of the metal tube via sintering.

32. The metal tube with metal foam liner of any one of claims 1 to 30, wherein the outer wall of the metal foam liner is thermo-conductively bonded to the inner wall of the metal tube via brazing.

33. The metal tube with metal foam liner of any one of claims 1 to 32, wherein the metal tube is seamless.

34. The metal tube with metal foam liner of any one of claims 1 to 33, wherein the at least one open end of the metal tube is a first open end, and the metal tube has a second open end.

35. The metal tube with metal foam liner of any one of claims 1 to 34, wherein the at least one open end of the metal tube is free of burrs.

36. The metal tube with metal foam liner of any one of claims 1 to 35, wherein the metal tube is straight.

37. The metal tube with metal foam liner of any one of claims 1 to 35, wherein the metal tube is curved.

38. The metal tube with metal foam liner of any one of claims 1 to 37, wherein a length of the metal foam liner is equal to the length of the metal tube.

39. The metal tube with metal foam liner of any one of claims 1 to 37, wherein a length of the metal foam liner is shorter than the length of the metal tube, and
further comprising a sintered powder liner thermo-conductively bonded to the metal tube, the sintered powder liner being located at least a portion of the inner wall of the metal tube not lined with the metal foam liner.

40. The metal tube with metal foam liner of claim 39, wherein a thickness of the sintered powder liner is smaller than the thickness of the metal foam liner.

41. The metal tube with metal foam liner of any one of claims 1 to 39, wherein a length of the metal foam liner is shorter than the length of the metal tube, and the metal foam liner is a first metal foam liner covering a first portion of the inner wall of the metal tube, and
further comprising at least a second liner covering a second portion of the inner wall of the metal tube, the second portion being free of the first metal foam liner, the second liner being one or more of a sintered powder liner and a metal foam liner.

42. The metal tube with metal foam liner of any one of claims 1 to 41, wherein:
the outer diameter of the metal tube is 6 mm;
the length of the metal tube is 300 mm;
the wall thickness of the metal tube is 0.3 mm;
the thickness of the metal foam liner is 0.7 mm;
the permeability and the capillarity radius of the metal foam liner are such that a ratio of permeability over capillarity radius is maximized;
the thermo-conductivity of the metal foam liner is of between 20 W/m·K and 30 W/m·K; and
the porosity of the metal foam liner is of between 70% and 85% void volume.

43. The metal tube with metal foam liner of claim 42, wherein the thermo-conductivity of the metal foam liner is of 30 W/m·K, and the porosity of the metal foam liner is of between 70% and 82% void volume.

44. The metal tube with metal foam liner of any one of claims 42 to 43, wherein:
a heat resistance of the metal tube with the metal foam liner at 20 W is about 0.8° C./W;
a porosity of the sintered powder liner is 45% void volume; and
a heat resistance of the metal tube with the sintered powder liner at 20 W is about 0.3° C./W.

45. The metal tube with metal foam liner of any one of claims 42 to 43, wherein:
a heat resistance of the metal tube with the metal foam liner at 35 W is about 0.5° C./W;
a porosity of the sintered powder liner is between 45% and 55% void volume; and
a heat resistance of the metal tube with the sintered powder liner at 35 W is about 0.3° C./W.

46. A method for making a metal tube lined with a metal foam liner comprising:
providing a metal tube of desired characteristics;
providing a metal foam liner of desired characteristics, the desired characteristics including the metal foam liner having an outer wall adapted to contact at least partially an inner wall of the metal tube;
providing a mandrel adapted to contact and apply a slight compression onto the inner wall of the metal foam liner, an external surface of the mandrel being non-bonding with the metal foam liner;
inserting the metal foam liner inside the metal tube to form a tube-liner assembly;
inserting the mandrel inside the tube-liner assembly;
applying radial compression onto the inner wall of the metal foam liner via the insertion of the mandrel into the tube-liner assembly;
applying a heating treatment to the tube-liner assembly with the mandrel inserted therein to bond at least partially the outer wall of the metal liner to the inner wall of the metal tube;
cooling down the tube-liner assembly with the mandrel inserted therein; and
removing the mandrel from the tube-liner assembly.

47. The method for making a metal tube with metal foam liner of claim 46, wherein a non-bonding material on the external surface of the mandrel is selected from a group consisting of boron nitride, stainless steel, and graphite.

48. The method for making a metal tube with metal foam liner of any one of claims 46 to 47, wherein the mandrel is longer than the metal tube; and
the method further comprises adjusting the mandrel in the tube-liner assembly so as to have ends of the mandrel extending on each side of the tube-liner assembly, before applying the heating treatment.

49. The method for making a metal tube with metal foam liner of any one of claims 46 to 48, further comprising securing the ends of the mandrel fixed during the heating treatment.

50. The method for making a metal tube with metal foam liner of any one of claims 46 to 49, wherein the heating treatment is done in a hydrogen nitrogen mixture atmosphere.

51. The method for making a metal tube with metal foam liner of any one of claims 46 to 49, wherein the heating treatment is done in a vacuum.

52. The method for making a metal tube with metal foam liner of any one of claims 46 to 51, wherein the cooling down is done in an atmosphere that hinders oxidation.

53. The method for making a metal tube with metal foam liner of any one of claims 46 to 52, wherein the cooling down is done passively by leaving the tube-liner assembly in an environment at room temperature until a temperature of the tube-liner assembly is the room temperature.

54. The method for making a metal tube with metal foam liner of any one of claims 46 to 53, wherein at least one of inserting the metal foam liner inside the metal tube and inserting and removing the mandrel from the tube-liner assembly, is done by sliding at least one of the metal foam liner, the metal tube and the mandrel with respect to one another.

55. The method for making a metal tube with metal foam liner of any one of claims 46 to 54, wherein the heating treatment is done at 1050 degrees C. for 8 hours, and results in sintering the outer wall of the metal foam liner to the inner wall of the metal tube.

56. The method for making a metal tube with metal foam liner of any one of claims 46 to 55, wherein:
the desired characteristics of the metal tube include the metal tube having an outer diameter of between 2 mm and 75 min, a length of between 50 mm and 1000 mm, a wall thickness of between 0.2 mm and 2 mm; and
the desired characteristics of the metal foam liner include a thickness of between 0.1 mm and 10 mm, a permeability of between 10⁻¹³ m² and 10⁻⁸ m², a capillarity radius of between 5 μm and 1 mm, a thermo-conductivity of between 1 W/m·K and 50 W/m·K, and porosity of between 40% and 90% void volume.

57. The method for making a metal tube with metal foam liner of any one of claims 46 to 56, wherein:
the desired characteristics of the metal tube include the metal tube having an outer diameter of between 4 mm and 50 mm, a length of between 50 mm and 1000 mm, a wall thickness of between 0.2 mm and 2 mm; and
the desired characteristics of the metal foam liner include a thickness of between 0.1 mm and 10 mm, a permeability of between 10¹¹ m² and 10⁻⁹ m², a capillarity radius of between 20 μm and 250 a thermo-conductivity of between 5 W/m·K and 30 W/m·K, and porosity of between 50% and 82% void volume.

58. The method for making a metal tube with metal foam liner of any one of claims 46 to 57, wherein a length of the metal foam liner is shorter than the length of the metal tube; and
further comprising pouring powder metal particles in between the mandrel and the inner wall of the metal tube where at least a portion of the metal tube is not lined with the metal foam liner, before applying the heating treatment.

59. The method for making a metal tube with metal foam liner of any one of claims 46 to 57,
wherein the metal foam liner is a first metal foam liner, and a length of the first metal foam liner is shorter than the length of the metal tube; and
further comprising inserting at least one second metal foam liner inside the metal tube after inserting the first metal foam liner inside the tube to form the tube-liner assembly, before inserting the mandrel in the tube-liner assembly.

60. The method for making a metal tube with metal foam liner of claim 59, wherein the mandrel has a first portion and a second portion, the first portion having a first cross-section, the second portion having a second cross-section, the first portion having a length of a length of the metal foam liner, the second section having a length of a length of the at least portion of the metal tube not lined with the metal foam liner, the first cross-section being different from the second cross-section.

61. A method for making a tube of metal foam comprising:
providing a sheet of metal foam of desired characteristics and dimensions;
providing a jig having a groove, the groove having at least a portion shaped and dimensioned to coincide with a shape and dimension of an outer surface of the tube of metal foam to be made;
providing a cylindrical mandrel of a diameter substantially equal to an inner diameter of the tube of metal foam to be made;
placing the sheet of metal foam onto the jig above the groove;
placing the mandrel aligned with the groove on top of the sheet of metal foam;
pressing the mandrel onto the sheet of metal foam into the groove, the pressing resulting in bending at least partially the sheet of metal foam;
lifting the mandrel up;
repeatedly placing remaining flat portions of the sheet of metal foam onto the jig above the groove, placing the mandrel aligned with the groove on top of the sheet of metal foam, and pressing the mandrel onto the sheet of metal foam into the groove, until the sheet of metal foam forms the tube of metal foam to be made; and
removing the mandrel from the tube of metal foam once the tube of metal foam is made.

62. The method for making a tube of metal foam of claim 61, further comprising holding the metal sheet in place onto the jig, before pressing the mandrel onto the sheet of metal foam into the groove.

63. The method for making a tube of metal foam of any one of claims 61 to 62, wherein the groove is a semicircular-shaped longitudinal groove having a diameter substantially equal to an outer diameter of the tube of metal foam to be made.

64. The method for making a tube of metal foam of any one of claims 61 to 63, wherein the groove is a second recess;
the jig further comprises a first recess, the second recess being within the first recess, the second recess being deeper than the first recess, the first recess having a width of at least a width of the sheet of metal foam, the first recess having at least one open end, the second recess being at an angle with respect to the at least one open end of the first recess; and
when the sheet of metal foam is placing onto the jig, the sheet of metal foam is placed into the first recess.

65. The method for making a tube of metal foam of any one of claims 61 to 64, wherein the second recess is perpendicular to the open end of the first recess.

66. The method for making a metal tube with metal foam liner of any one of claims 61 to 65, wherein the desired characteristics include having a width of the metal foam sheet substantially equal to a perimeter of an outer cross-section of the desired tube of metal foam liner.

67. A jig used for rolling a sheet of porous metal into a tube, the jig comprising:
a first recess having at least one open end, the first recess having a width adapted to be at least a width of the sheet of porous metal;
a second recess within the first recess, the second recess being a groove having at least a portion adapted to coincide with an outer surface of the tube to be made, the second recess being deeper than the first recess, the second recess being at an angle with respect to the at least one open end of the first recess.
